(19) United States
(12) Patent Application Publication
(10) Pub. No.: US 2007/0268010 A1
(43) Pub. Date: Nov. 22, 2007

(54) Voltage regulator with a wire arranging structure

(76) Inventor: Fan Tsai, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/437,690

(22) Filed: May 22, 2006

(51) Int. Cl. G05F 3/00

(52) U.S. Cl. 323/304

(57) ABSTRACT

A voltage regulator with a wire arranging structure is formed integrally with an insulated wire, and receives the insulated wire therein in a winding manner. The present invention has a collecting member extending from and covering the insulated wire. The collecting member has at least one accommodating groove and a surrounding groove. The accommodating groove is formed concavely from a periphery of the collecting member and passes through the collecting member in a lengthwise direction of the collecting member. The surrounding groove is formed concavely from a periphery of the collecting member in a helix-like structure.

### BACKGROUND OF THE INVENTION

1. Field of the Invention

The present invention relates to a voltage regulator with a wire arranging structure, and particularly to a voltage regulator having an integral wire arranging structure that encircles an insulated wire so that the insulated wire can be arranged and wound. The present invention is particularly utilized to a flexible insulated wire that connects an electronic product to a power source and is covered by an insulated layer.

2. Description of the Prior Art

Power connecting wires have become indispensable because electronic mechanisms and equipment are used so commonly throughout the modern world. Wires for transmitting electric current are usually equipped with voltage-regulating plugs in civil industry, which are used widely in every kind of equipment and machine, such as transformers, electric shavers, desk lamps, computer peripherals, rechargeable tools, etc.

Most wires used for connecting machines and a power source are insulated wires (Insulated Electrical Wire). An insulated wire is usually composed of multiple metal wires and a layer of insulation covering the outside. If the insulated wire is not arranged properly it will not only have a disorderedly appearance but there will also be a danger of electrical shock because of any exposed conductive wires with broken insulated layers.

The conventional way for arranging insulated wires requires tools for binding the wires. For example, the wires are firstly folded and then bound using a binding tool. However, the binding tool is separated from the insulated wire and is easily lost. Furthermore, after the insulated wire is folded it is still exposed outside, so it is possible that someone can rub or scrap up against the wire resulting in such dangers as an electrical shock or a fire breaking out.

With the above-described problems of the prior art in view, an object of the present invention is to provide a voltage regulator with a wire arranging structure that overcomes the disadvantages of the prior art.

### SUMMARY OF THE INVENTION

An object of the present invention is to provide a voltage regulator with a wire arranging structure, which encircles an insulated wire integrally and is not separated from the insulated wire, and the insulated wire can be received regularly therein without being exposed at all, thus avoiding the dangers caused by accidentally contact.

In order to achieve the main object, the present invention provides a voltage regulator with a wire arranging structure that includes an insulated wire and a collecting member. The insulated wire extends from one end of a voltage-regulating plug. The collecting member extends from a periphery of the insulated wire. The collecting member forms at least one accommodating groove and a surrounding groove for receiving the insulated wire. The accommodating groove is formed concavely from a periphery of the collecting member and passes through the collecting member along lengthwise directions of the collecting member. The surrounding grooves are formed concavely from a periphery of the collecting member in a helix-like structure.

### BRIEF DESCRIPTION OF THE DRAWINGS

The invention will be better understood and objects other than those set forth above will become apparent when consideration is given to the following detailed description thereof. Such description makes reference to the attached drawings wherein:

FIG. 1 is a perspective view of a voltage regulator with a wire arranging structure according to the present invention;

FIG. 2 is a cross-sectional side view along line 2-2 in FIG. 1 according to the present invention;

FIG. 3 is a perspective view of a voltage regulator with a wire arranging structure after the wires are arranged according to the present invention;

FIG. 4 is a side view of a voltage regulator with a wire arranging structure after the wires are arranged according to the present invention; and

FIG. 5 is another perspective view of a voltage regulator with a wire arranging structure according to the present invention.

### DESCRIPTION OF THE PREFERRED EMBODIMENT

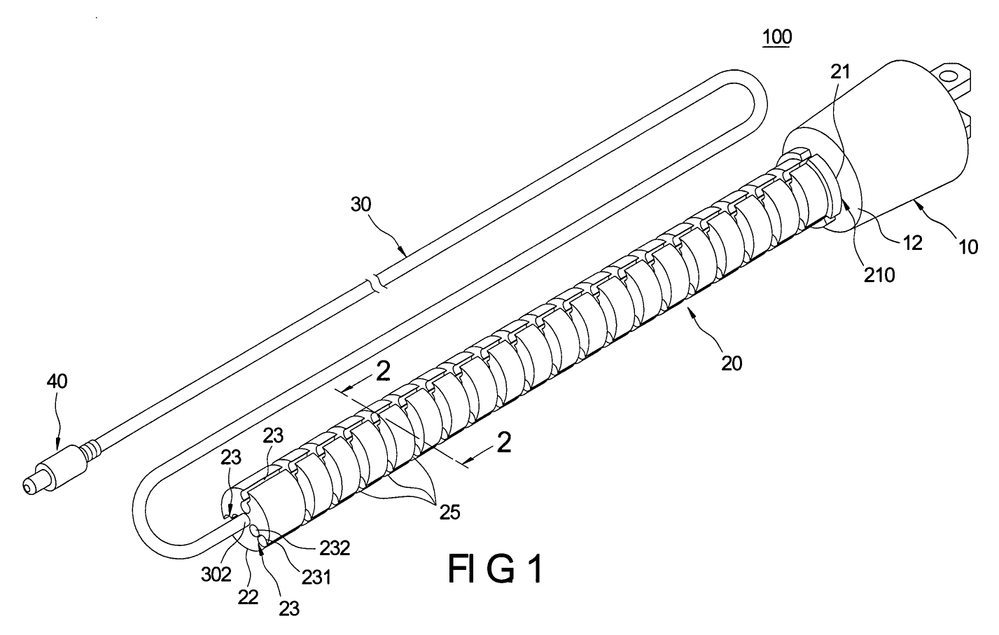

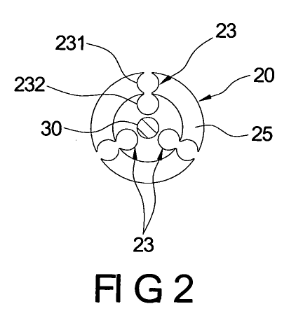

Reference is made to FIGS. 1 and 2, which are a perspective view of a voltage regulator with a wire arranging structure according to the present invention and a cross-sectional side view along line 2-2 in FIG. 1 according to the present invention. The present invention provides a wire arranging structure 100, which can accommodate an insulated wire 30 in a winding manner. It solves the disadvantages of prior art that a wire is difficult to arrange and is still exposed outside. The voltage regulator with a wire arranging structure 100 includes a collecting member 20 that extends from and covers the insulated wire 30.

In this embodiment, the present invention is illustrated with a voltage regulator to aid the description. The collecting member 20 has a connecting end 21 and a free end 22. The connecting end 21 connects to a voltage-regulating plug 10, and the insulated wire 30 is electrically connected with the voltage-regulating plug 10. An annular gap 210 is formed between the connecting end 21 of the collecting member 20 and a bottom surface 12 of the voltage-regulating plug 10. An electrical connector 40 is connected to one end of the insulated wire 30 that is opposite to the voltage-regulating plug 10. The aforementioned embodiment is only illustrated for describing the present invention, but it is not limited by it. The present invention can be utilized to other electrical devices with a long insulated wire. Furthermore, the collecting member 20 can be disposed at a central portion of the insulated wire 30 and is not limited to being close to the voltage-regulating plug or the electrical connector.

The collecting member 20 is made of insulated material and is preferably made integrally with the insulated wire 30. For example, the collecting member 20 can be formed via injection technology when manufacturing the voltage-regulating plug 10, and the collecting member 20 can connect to the voltage-regulating plug 10. However, the present invention is not limited by this embodiment. The collecting member 20 can also be independently assembled to the insulated wire 30 after manufacture.

The collecting member 20 includes at least one accommodating groove 23 and a surrounding groove 25. The accommodating groove 23 is formed concavely from a periphery of the collecting member 20 and passes through the collecting member 20 along lengthwise directions of the collecting member 20. The surrounding groove 25 is formed concavely from a periphery of the collecting member 20 in a helix-like structure.

In this preferred embodiment, the collecting member 20 is shaped like a column and forms three accommodating grooves 23. In detail, the collecting member 20 extends outwardly from the insulated wire 30 at a center. The accommodating grooves 23 are formed concavely from a periphery of the collecting member 20 in a radial direction. The number of accommodating grooves 23 is an odd number and the accommodating grooves 23 are formed in the collecting member 20 in an isogonal manner, so that the insulated wire 30 can be arranged so that its two ends can be turned back to an original position.

Reference is made to FIG. 2. In this preferred embodiment, the accommodating groove 23 includes an outer column-shaped groove 231 and an inner column-shaped groove 232. The outer column-shaped groove 231 is formed concavely from the periphery of the collecting member 20 and is communicated with outside. The inner column-shaped groove 232 is communicated with the outer column-shaped groove 231 and is located between the insulated wire 30 and the outer column-shaped groove 231. A diameter of the inner column-shaped groove 232 is equal to or greater than that of the insulated wire 30 for clipping the insulated wire 30 being received therein.

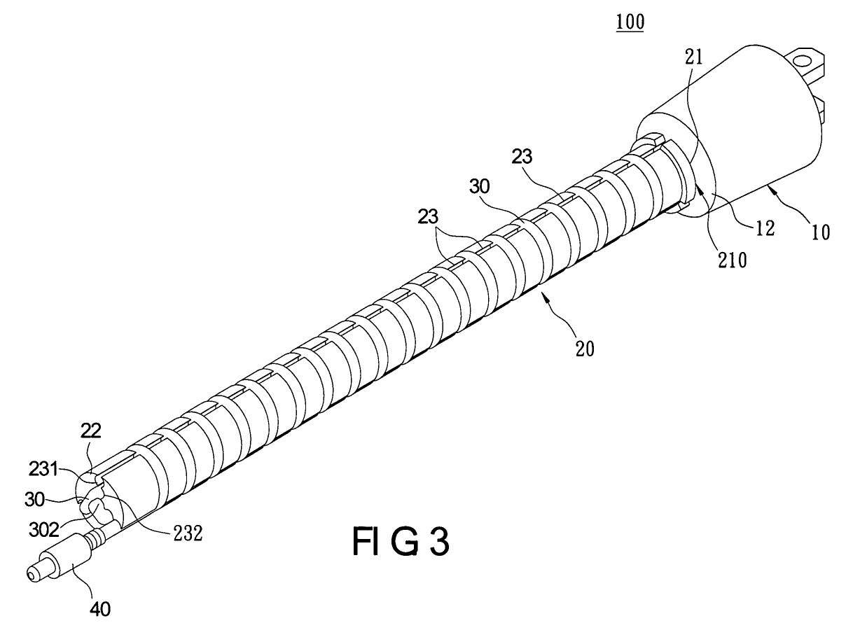

Reference is made to FIG. 3, which is a perspective view of a voltage regulator with a wire arranging structure after the wires are arranged according to the present invention. The wire arranging processes of the present invention are described as follows:

Firstly, the insulated wire 30 is bent from a linking part 302 toward one of the accommodating grooves 23, wherein the linking part 302 is connected with the collecting member 20. Then, the insulated wire 30 is pushed into the outer column-shaped groove 231 and sequentially into the inner column-shaped groove 232. Next, the insulated wire 30 is wound around the annular gap 210 between the collecting member 20 and the voltage-regulating plug 10. Next, the insulated wire 30 is pushed into another of the accommodating grooves 23. The insulated wire 30 is wedged into the inner column-shaped groove 232 through the outer column-shaped groove 231. The insulated wire 30 is next wound into the third groove of the accommodating grooves 23. Finally, the insulated wire 30 is wound in the surrounding groove 25 along the periphery of the collecting member 20, and returns to the original direction of the insulated wire 30.

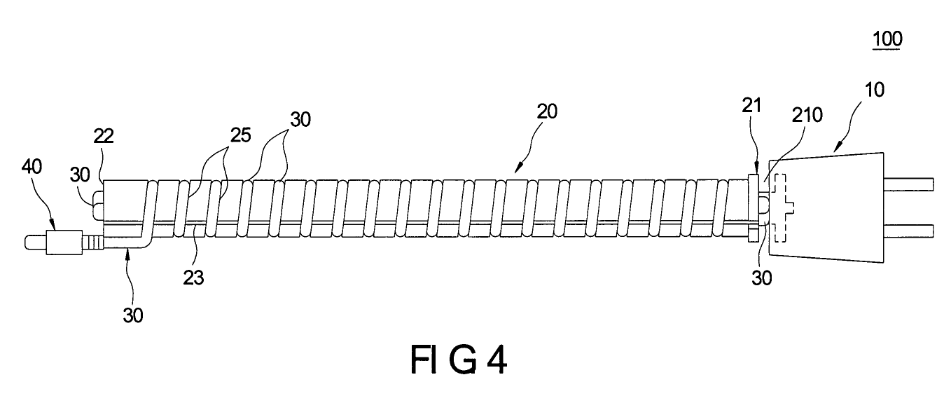

Reference is made to FIG. 4, which is a side view of a voltage regulator with a wire arranging structure after the wires have been arranged according to the present invention. The insulated wire 30 having been arranged is completely received in the collecting member 20 and has no exposed parts, which is very convenient and orderly. Therefore, anyone who passes by and scrapes up against the insulated wire 30 is protected. A section of the insulated wire 30 can remain outside of the collecting member 20 according to the user's needs. For example, the insulated wire 30 can be wedged into only one of the accommodating grooves 23, and a section of the insulated wire can be left for use as the user desires.

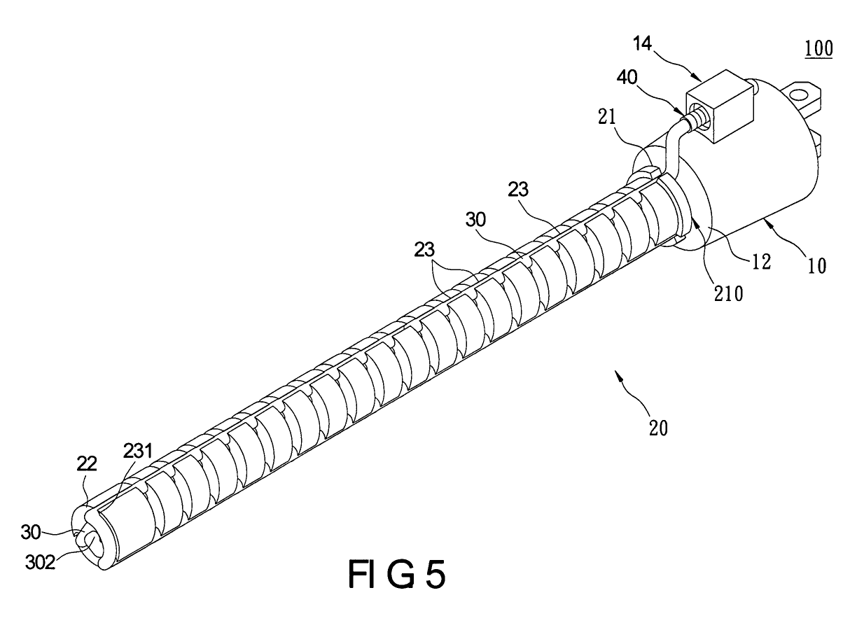

Reference is made to FIG. 5, which is another perspective view of a voltage regulator with a wire arranging structure according to the present invention. The present invention can further include a fixing member 14 disposed on the voltage-regulating plug 10 to attach the electrical connector 40 of the insulated wire 30. The insulated wire 30 can return to the voltage-regulating plug 10, and is fixed on the voltage-regulating plug 10 by the fixing member 14. The voltage regulator with a wire arranging structure 100 is therefore more orderly, and the insulated wire 30 is completely received therein and no parts are exposed. In this embodiment, the fixing member 14 is a protruded shell, but it is changeable. For example, the fixing member 14 can be a Nylon Fastener that can be used repeatedly.

In summation, the voltage regulator with a wire arranging structure of the present invention has the following advantages:

The voltage regulator with a wire arranging structure of the present invention is formed integrally with the insulated wire so it is convenient for users to arrange any surplus insulated wire. The insulated wire is received therein for preventing anyone who scrapes up against the exposed wires from receiving an electrical shock. Users do not require additional tools for arranging the insulated wire.

The description above only illustrates specific embodiments and examples of the invention. The invention should therefore covers various modifications and variations made to the herein-described structure and operations of the invention, provided they fall within the scope of the invention as defined in the following appended claims.

What is claimed is:

1. A voltage regulator with a wire arranging structure, comprising:
an insulated wire extending from one end of a voltage-regulating plug; and
a collecting member forming with at least one accommodating groove and a surrounding groove for receiving the insulated wire, wherein the accommodating groove is formed concavely from a periphery of the collecting member and passes through the collecting member in lengthwise directions of the collecting member, and the surrounding groove is formed concavely from a periphery of the collecting member in a helix-like structure.

2. The voltage regulator with a wire arranging structure as claimed in claim 1, wherein the collecting member has one end connecting with the voltage-regulating plug, and the insulated wire electrically connects with the voltage-regulating plug.

3. The voltage regulator with a wire arranging structure as claimed in claim 2, wherein an annular gap is formed between the collecting member and the voltage-regulating plug.

4. The voltage regulator with a wire arranging structure as claimed in claim 2, wherein an electrical connector is connected with an end of the insulated wire that is opposite to the voltage-regulating plug.

5. The voltage regulator with a wire arranging structure as claimed in claim 2, wherein the collecting member is formed integrally around the insulated wire, and is formed via injection technology to encircle with the voltage-regulating plug integrally.

6. The voltage regulator with a wire arranging structure as claimed in claim 1, wherein the collecting member is column-shaped.

7. The voltage regulator with a wire arranging structure as claimed in claim 6, wherein the collecting member extends outwardly from the insulated wire at a center, and the accommodating groove is formed concavely from a periphery of the collecting member in a radial direction.

8. The voltage regulator with a wire arranging structure as claimed in claim 1, wherein a number of the accommodating grooves is an odd number and is formed in the collecting member in a isogonal manner.

9. The voltage regulator with a wire arranging structure as claimed in claim 1, wherein the accommodating groove is composed of an outer column-shaped groove and an inner column-shaped groove, and the outer column-shaped groove is formed concavely from the periphery of the collecting member, the inner column-shaped groove communicates with the outer column-shaped groove and is located between the insulated wire and the outer column-shaped groove.

10. The voltage regulator with a wire arranging structure as claimed in claim 9, wherein a diameter of the inner column-shaped groove is equal to or greater than that of the insulated wire for clipping the insulated wire received therein.

11. The voltage regulator with a wire arranging structure as claimed in claim 1, wherein the voltage-regulating plug has a fixing member for attaching the electrical connector.
